(19) United States
(12) Patent Application Publication
(10) Pub. No.: US 2021/0377094 A1
(43) Pub. Date: Dec. 2, 2021

(54) IN-PHASE AND QUADRATURE-PHASE TRACKING REFERENCE SIGNAL

(71) Applicant: QUALCOMM Incorporated, San Diego, CA (US)

(72) Inventors: David YUNUSOV, Holon (IL); Assaf TOUBOUL, Netanya (IL); Shay LANDIS, Hod Hasharon (IL)

(21) Appl. No.: 16/883,188

(22) Filed: May 26, 2020

(51) Int. Cl. H04L 27/36; H04L 5/10; H04L 5/00; H04L 27/26; H04L 25/02; H04W 24/10

(52) U.S. Cl. CPC H04L 27/364; H04L 5/10; H04W 24/10; H04L 27/2613; H04L 25/0204; H04L 5/0048

(57) ABSTRACT

The present aspects provide apparatuses, methods, and computer-readable medium for wireless communication at a user equipment (UE), including receiving, from a base station, an in-phase and quadrature-phase tracking reference signal (IQTRS) configured for an estimation of an IQ impairment at the UE; estimating the IQ impairment based on the IQTRS; and compensating for the IQ impairment in a decoding process configured to decode one or more signals received from the base station.

### BACKGROUND

The present disclosure relates generally to communication systems, and more particularly, to in-phase and quadrature-phase (IQ) impairment compensation.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Due to the increasing demand for wireless communications, there is a desire to improve the efficiency of wireless communication network techniques.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of wireless communication at a user equipment (UE) includes receiving, from a base station, an in-phase and quadrature-phase tracking reference signal (IQTRS) configured for an estimation of an IQ impairment at the UE; estimating the IQ impairment based on the IQTRS; and compensating for the IQ impairment in a decoding process configured to decode one or more signals received from the base station.

In a further example, a UE for wireless communication includes a transceiver, a memory configured to store instructions, and one or more processors communicatively coupled with the transceiver and the memory. The one or more processors are configured to execute the instructions to receive, from a base station, an IQTRS configured for an estimation of an IQ impairment at the UE; estimate the IQ impairment based on the IQTRS; and compensate for the IQ impairment in a decoding process configured to decode one or more signals received from the base station.

In another aspect, a UE for wireless communication includes means for receiving, from a base station, an IQTRS configured for an estimation of an IQ impairment at the UE; means for estimating the IQ impairment based on the IQTRS; and means for compensating for the IQ impairment in a decoding process configured to decode one or more signals received from the base station.

In yet another aspect, a non-transitory computer-readable medium includes code executable by one or more processors to perform wireless communication at a UE, including receiving, from a base station, an IQTRS configured for an estimation of an IQ impairment at the UE; estimating the IQ impairment based on the IQTRS; and compensating for the IQ impairment in a decoding process configured to decode one or more signals received from the base station.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with an aspect of the present disclosure.

FIG. 2A is a diagram illustrating an example of a first 5G/NR frame, in accordance with an aspect of the present disclosure.

FIG. 2B is a diagram illustrating an example of DL channels within a 5G/NR subframe, in accordance with an aspect of the present disclosure.

FIG. 2C is a diagram illustrating an example of a second 5G/NR frame, in accordance with an aspect of the present disclosure.

FIG. 2D is a diagram illustrating an example of UL channels within a 5G/NR subframe, in accordance with an aspect of the present disclosure.

FIG. 3A is a graph of amplitude versus frequency of an example baseband signal, in accordance with an aspect of the present disclosure.

FIG. 3B is a graph of amplitude versus frequency of an example bandpass signal, in accordance with an aspect of the present disclosure.

FIG. 4 is an example of desired constellation points in 64 quadrature amplitude modulation (QAM), and respective received constellation points that are distorted due to In-phase and Quadrature-phase (IQ) impairments, in accordance with an aspect of the present disclosure.

FIG. 5 is an example of desired constellation points in 1024 QAM, and respective received constellation points that are distorted due to IQ impairments, in accordance with an aspect of the present disclosure.

FIG. 6 is a graph of amplitude versus frequency of an example IQ tracking reference signal (TRS), in accordance with an aspect of the present disclosure.

FIG. 7 is a diagram illustrating example resource elements (REs) including IQTRS in symbols of a downlink transmission period, in accordance with an aspect of the present disclosure.

FIG. 8 is a diagram illustrating an example of a base station and user equipment (UE) in an access network.

FIG. 9 is a flowchart of a method of wireless communication, in accordance with an aspect of the present disclosure.

FIG. 10 is a block diagram illustrating an example of a UE, in accordance with various aspects of the present disclosure.

FIG. 11 is a block diagram illustrating an example of a base station, in accordance with various aspects of the present disclosure.

### DETAILED DESCRIPTION

Aspects of the present disclosure provide one or more waveforms for transmission by a base station (e.g., over a downlink shared channel) to allow for In-phase and Quadrature-phase (IQ) impairment compensation at a user equipment (UE) during the operational transmission of the UE, e.g., during the decoding process thus providing online IQ impairment compensation. In one non-limiting aspect, for example, a base station may transmit an IQ tracking reference signal (IQTRS) around a local oscillator (LO) frequency of the base station. Accordingly, a UE that knows the LO frequency may receive the IQTRS, estimate IQ impairments based on the IQTRS, and online compensate for the IQ impairments without the need for any calibration such as self-calibration using a feedback loop. By provisioning waveforms that allow for online compensation of IQ impairments at a UE, the present aspects may support improved wireless communication features such as higher data rates, higher capacity, improved spectral efficiency, etc.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Although the following description may be focused on 5G NR, the concepts described herein may be applicable to other similar areas, such as LTE, LTE-A, CDMA, GSM, and other wireless technologies.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

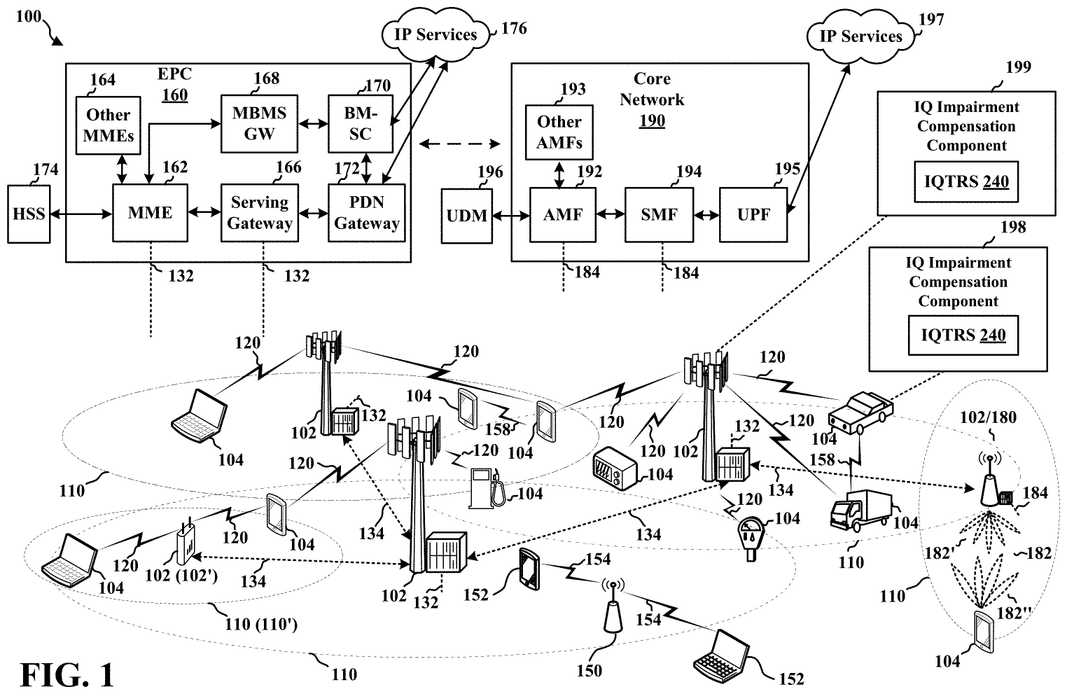

FIG. 1 is a diagram illustrating an example of a wireless communications system and an access network 100 that includes base stations 102 and UEs 104 configured for online IQ impairment compensation at the UEs 104. Specifically, in certain aspects, one or more base stations 102 may be configured to operate an IQ impairment compensation component 199 to facilitate transmission of one or more waveforms such as an IQTRS 240 to one or more UEs 104. Correspondingly, one or more UEs 104 may be configured to operate an IQ impairment compensation component 198 for online compensation of IQ impairments at the UEs 104 based on the IQTRS 240 received from a base station 102. Further details related to online compensation of IQ impairments are provided below with reference to various example aspects.

Still referring to FIG. 1, the wireless communications system 100 (also referred to as a wireless wide area network (WWAN)) further includes an Evolved Packet Core (EPC) 160 and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with the core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 132, 134, and 184 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158, e.g., including synchronization signals. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

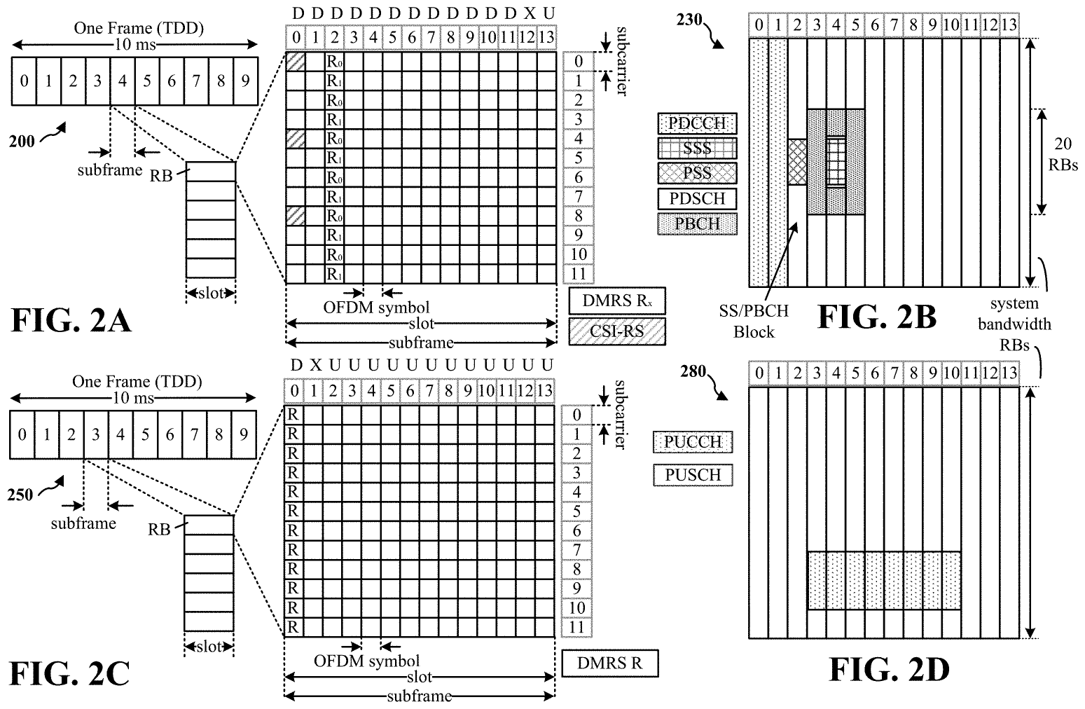

FIGS. 2A-2D include diagrams of example frame structures and resources that may be utilized in communications between the base stations 102, the UEs 104, and/or the secondary UEs (or sidelink UEs) 110 described in this disclosure. FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame.

The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

OFDM systems suffer from radio frequency (RF) impairments such as IQ imbalances/impairments in the analog part at the transmitter and/or receiver sides. Specifically, when a received signal with an RF frequency is down-converted into a baseband frequency, RF impairments are incurred if the In-phase and Quadrature-phase paths are not RF-matched in phase or amplitude. The resulting distortion degrades performance and introduces some noise floor that limits the operational signal to noise ratio (SNR) at the receiver side. The impairments may be dominant especially in high modulation and coding schemes (MCSs), e.g., high data rates and/or high quadrature amplitude modulation (QAM) constellations.

In some cases, calibration or online training may be needed in order to compensate for such impairments. However, the present aspects obviate the need for calibration by providing a compensation scheme based on a waveform transmitted by a base station and received and used by a UE to compensate for IQ impairments.

By compensating online for IQ impairments, some present aspects can constantly achieve higher constellations (assuming that channel conditions apply) by reducing the noise floor that results from such impairments. These aspects also obviate the need for calibration procedures during UE startup (when the UE is turned on) or during UE reset, and also save the cost of base station calibration on the transmitter side.

Some systems may perform a calibration procedure at the gNB side for each transmit chain and also at the UE side during UE startup, without any online compensation during the operational transmission. However, these systems do not account for the local frequency drift which may result in IQ impairments. In these systems, supporting massive MIMO with high number of transmit chains requires calibrating each chain which may be resource expensive for a gNB.

In contrast, online IQ impairment compensation according to the present aspects provides power and time savings by obviating the need for the calibration operation at the gNB and at the UE. Some present aspects implement IQTRS to provide the capability to track IQ mismatches/impairments which are frequency selective/dependent due to the waveform characteristics. Further, in cases where gNB hardware upgrades are not available thus preventing progressing 5GNR toward higher MCS releases, allowing for the UE to compensate for IQ mismatches/impairments eliminates such hardware upgrade dependencies. For example, without online IQ impairment compensation, if a gNB can only support for up to 1K QAM, the IQ impairments may be a limiting factor for upgrading to a future release that requires support for 2K or 4K QAM, until gNB hardware is upgraded accordingly. However, the functionality provided by the present aspects eliminates such gNB hardware upgrade dependencies.

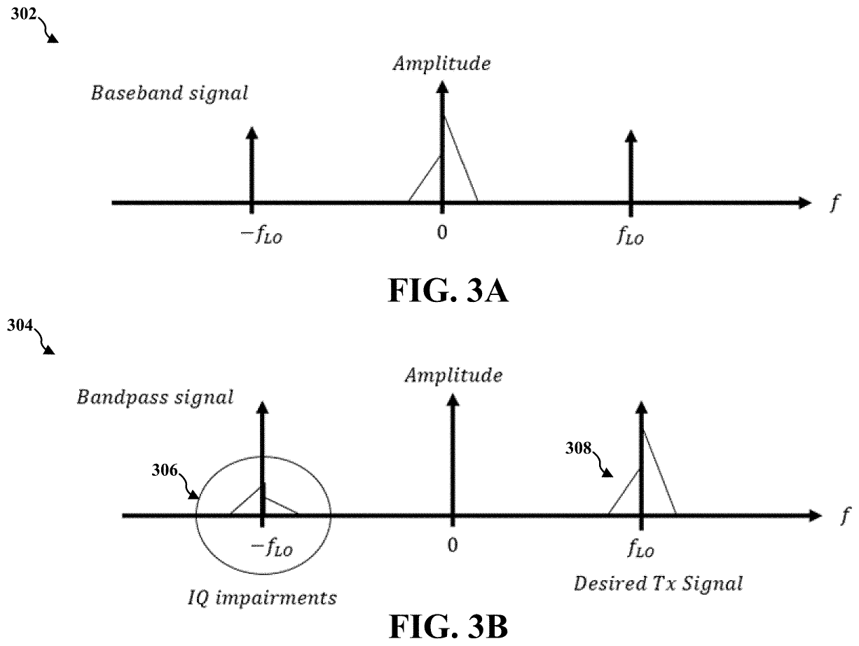

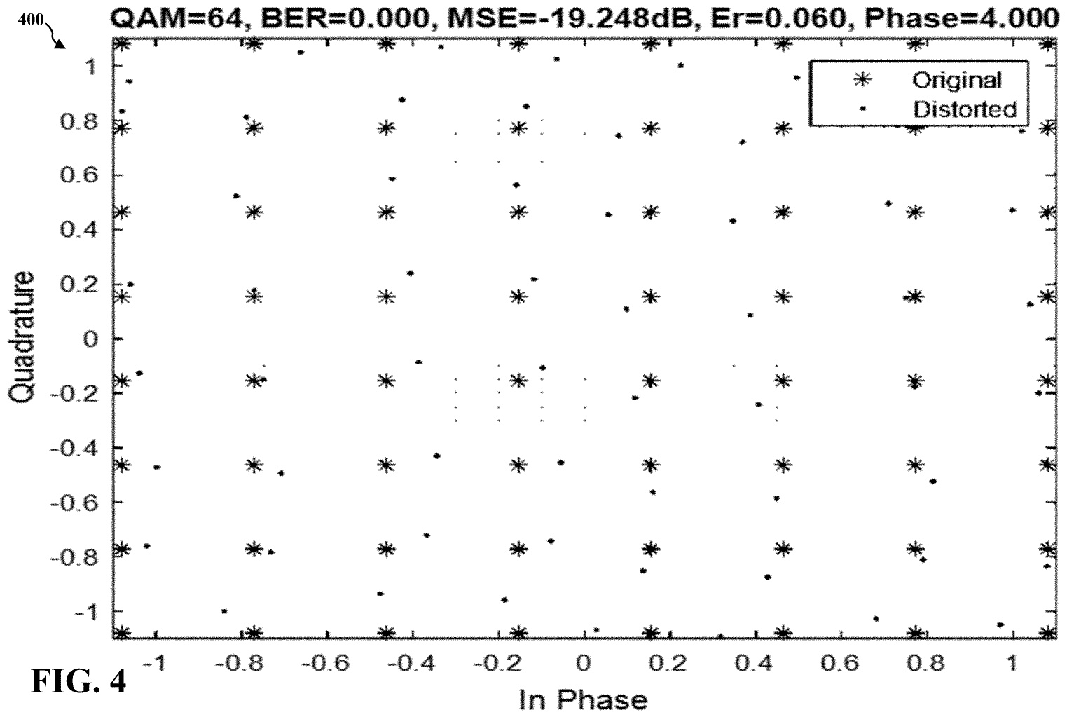

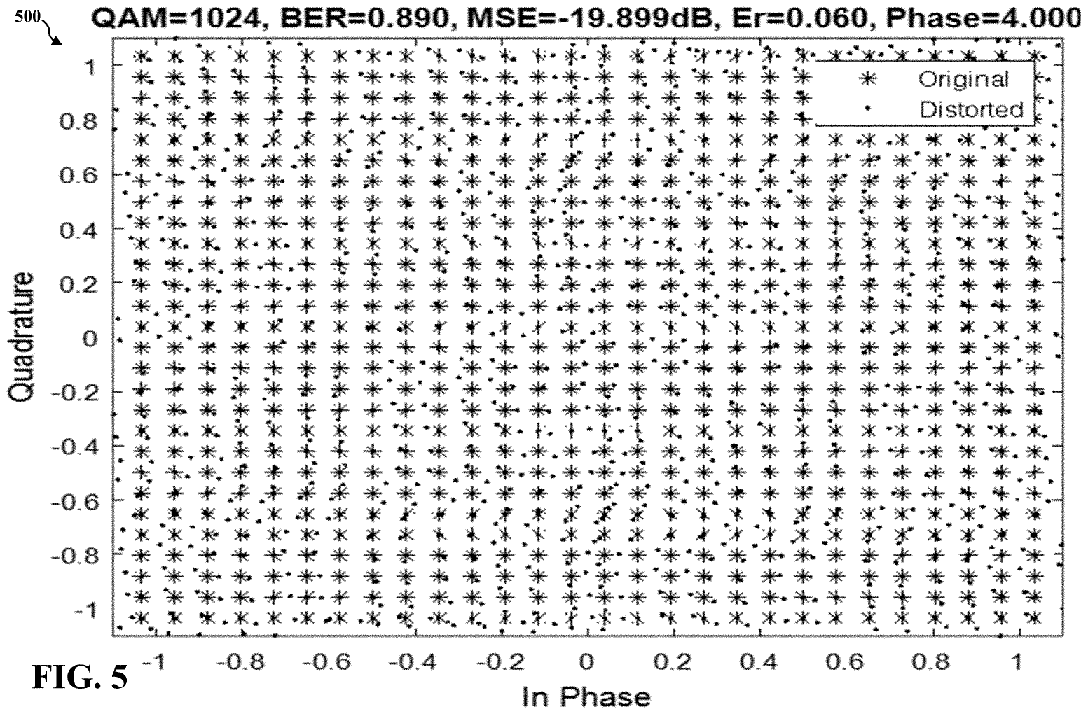

Referring to FIGS. 3A and 3B, at the analog front-end, a baseband signal 302 may be up-converted upon an LO frequency to result in a bandpass signal 304. However, when IQ paths are not matched by phase and/or amplitude, a mirrored image signal 306 occurs around the negative spectrum of the bandpass signal 304 (thus causing IQ impairments) and causes an error vector magnitude (EVM) impact in the desired transmit signal 308, as also described below with reference to example aspects in FIGS. 4 and 5.

Referring to FIGS. 4 and 5, IQ impairments may limit the operational SNR depending on the constellation size. When a hard decision slicer is used to obtain uncoded bit error rate (BER) results that differentiate whenever a wrong constellation is decoded, each decision needs to remain in a respective slicing zone in order to keep BER=0. Using such a hard decision slicer, for example, for the 64 QAM constellation points 400 in FIG. 4, an amplitude difference Eᵣ=0.06 and a phase difference Phase=4° leads to a mean square error (MSE) of ˜−20 dB and BER=0. However, for the example 1024 QAM constellation points 500 in FIG. 5, the same Eᵣ=0.06 and Phase=4° leads to an MSE of ˜−20 dB but a BER=0.89. Accordingly, the IQ impairments in the 1024 QAM constellation points 500 in FIG. 5 need to be compensated for in order to achieve BER=0. That is, although the constellation type does not impact the MSE resulting from IQ impairments, a higher constellation requires a lower MSE in order to achieve BER=0. Similarly, for example, for 16K QAM, an MSE >−45 dB is required to achieve BER=0, even without taking noise into account. This translates to a requirement for very low amplitude and phase impairments of Eᵣ=0.004, Phase=0.2°. Thus, in order to achieve BER=0, using a higher number of constellation points requires having a lower MSE level, which in turn requires lower tolerable levels of IQ impairments (Eᵣ, Phase).

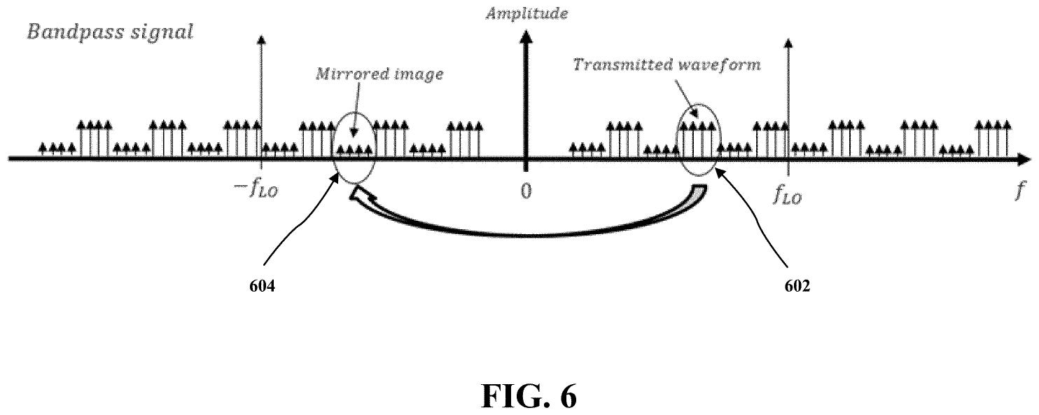

Referring to FIG. 6, in an aspect, for example, a gNB may transmit an IQTRS 602 configured around the LO frequency of the gNB, while the LO frequency is known at a receiver of a UE that receives the IQTRS 602 (for example, the UE may implement carrier frequency offset (CFO) estimation to synchronize with the LO frequency of the gNB). Due to IQ impairment properties, the IQTRS 602 may be configured to be sparse in the frequency domain but nonsymmetrical around the LO frequency. This configuration results in the mirrored image 604 of the IQTRS 602 to fall in between the transmitted signal, e.g., on some empty resource elements (REs). Since IQ mismatches are usually weaker than the desired transmitted signal (e.g., have lower amplitude than the desired transmitted signal), some aspects allocate the IQTRS 602 in specific places in the frequency domain in order to filter the signal and achieve processing gain over thermal noise. The UE may estimate the IQ impairments based on the IQTRS 602, thus being able to online compensate for the IQ impairments without the need for calibration.

In some aspects where a gNB implements analog beamforming on the downlink, the transmit chains of different beams may suffer from different IQ impairments. Hence, a UE may observe a superposition of the IQ impairments of different transmit chains of different beams. In this case, IQTRS functionality may be configured per beam since each beam may include a different combination of analog chains which can produce a different subset of IQ impairments.

In some example aspects, IQTRS may be implemented by separate/dedicated signaling with continuous allocation in specific places in the frequency domain in order to filter the signal and achieve processing gain over thermal noise.

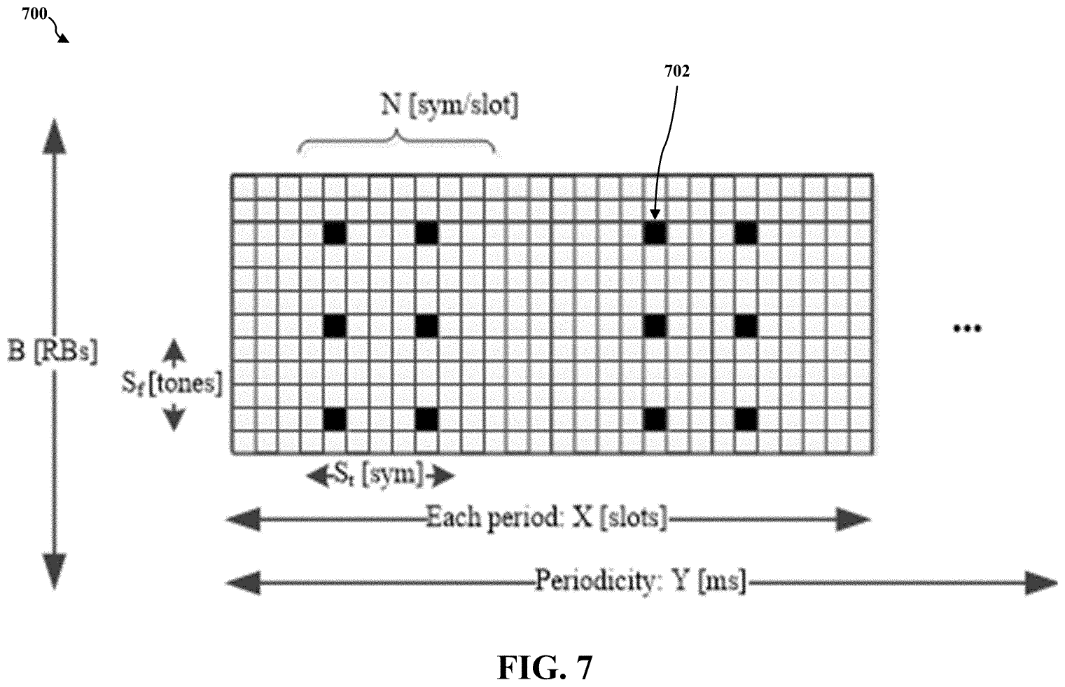

In some alternative and/or additional aspects, IQTRS may be implemented based on a TRS signal which can be placed anywhere in the frequency domain. For example, in one non-limiting aspect, referring to FIG. 7, each subframe 700 in a downlink communication may include two symbols, and IQTRS 702 may be implemented in each cluster of REs with 1:4 RE separation. In an aspect, IQTRS 702 may be implemented on a TRS with very low periodicity, for example, with a periodicity of 80 ms in 5G NR. In this case, the gNB may inform the UE as to when the gNB will transmit the IQTRS 702.

In yet other alternative and/or additional aspects, IQTRS may be implemented based on a DM-RS. For example, in some aspects, DM-RS is in every subframe (thus having high periodicity), in which case IQTRS may be implemented in the DM-RS that is decimated in frequency, e.g., decimated by two to provide a cluster of REs with 1:2 RE separation.

In an aspect, each cluster of REs used for IQTRS in the frequency domain may include an even number of REs on some frequencies around the LO frequency and may be configured such that the mirror image of the IQTRS in the frequency domain falls on un-occupied REs.

In some aspects, for modulation schemes having high constellation sizes, such as 256 QAM, 1024 QAM, 16384 QAM, etc., sensitivity to IQ mismatches/impairments which are frequency dependent may impose limitations. In particular, since IQ impairments are not dependent on the noise variance/power, IQ impairments may become a limiting factor to higher constellations even in high SNR and multiple antenna MIMO configurations. However, in some present aspects, signals of different antennas may be combined on the receive side before estimation of IQ impairments in order to achieve processing gain and estimate the IQ impairments more accurately.

In some aspects, compensation of IQ mismatches/impairments may be unique for each UE and may be performed in the transmit path through a feedback channel. For example, each UE may estimate IQ mismatches/impairments and then report the estimated IQ mismatches/impairments to the gNB using an IQTRS report, so that the gNB can compensate for the IQ mismatches/impairments for that UE. In some alternative and/or additional aspects, compensation of IQ mismatches/impairments may be performed in the receiver path as part of the channel estimation (CHEST) processing.

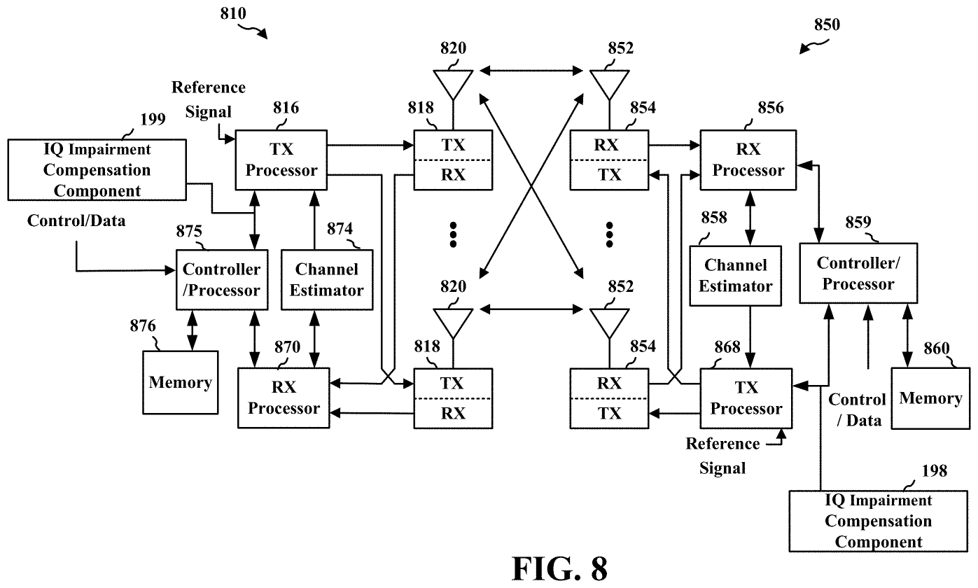

FIG. 8 is a block diagram of a base station 810 in communication with a UE 850 in an access network, where the base station 810 may be an example implementation of base station 102 and where UE 850 may be an example implementation of UE 104. In the DL, IP packets from the EPC 160 may be provided to a controller/processor 875. The controller/processor 875 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 875 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 816 and the receive (RX) processor 870 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 816 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 874 may be used to determine the coding and modulation scheme, as well as for spatial processing. The channel estimate may be derived from a reference signal and/or channel condition feedback transmitted by the UE 850. Each spatial stream may then be provided to a different antenna 820 via a separate transmitter 818TX. Each transmitter 818TX may modulate an RF carrier with a respective spatial stream for transmission.

At the UE 850, each receiver 854RX receives a signal through its respective antenna 852. Each receiver 854RX recovers information modulated onto an RF carrier and provides the information to the receive (RX) processor 856. The TX processor 868 and the RX processor 856 implement layer 1 functionality associated with various signal processing functions. The RX processor 856 may perform spatial processing on the information to recover any spatial streams destined for the UE 850. If multiple spatial streams are destined for the UE 850, they may be combined by the RX processor 856 into a single OFDM symbol stream. The RX processor 856 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 810. These soft decisions may be based on channel estimates computed by the channel estimator 858. The soft decisions are then decoded and deinterleaved to recover the data and control signals that were originally transmitted by the base station 810 on the physical channel. The data and control signals are then provided to the controller/processor 859, which implements layer 3 and layer 2 functionality.

The controller/processor 859 can be associated with a memory 860 that stores program codes and data. The memory 860 may be referred to as a computer-readable medium. In the UL, the controller/processor 859 provides demultiplexing between transport and logical channels, packet reassembly, deciphering, header decompression, and control signal processing to recover IP packets from the EPC 160. The controller/processor 859 is also responsible for error detection using an ACK and/or NACK protocol to support HARQ operations.

Similar to the functionality described in connection with the DL transmission by the base station 810, the controller/processor 859 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 858 from a reference signal or feedback transmitted by the base station 810 may be used by the TX processor 868 to select the appropriate coding and modulation schemes, and to facilitate spatial processing. The spatial streams generated by the TX processor 868 may be provided to different antenna 852 via separate transmitters 854TX. Each transmitter 854TX may modulate an RF carrier with a respective spatial stream for transmission.

The UL transmission is processed at the base station 810 in a manner similar to that described in connection with the receiver function at the UE 850. Each receiver 818RX receives a signal through its respective antenna 820. Each receiver 818RX recovers information modulated onto an RF carrier and provides the information to a RX processor 870.

The controller/processor 875 can be associated with a memory 876 that stores program codes and data. The memory 876 may be referred to as a computer-readable medium. In the UL, the controller/processor 875 provides demultiplexing between transport and logical channels, packet reassembly, deciphering, header decompression, control signal processing to recover IP packets from the UE 850. IP packets from the controller/processor 875 may be provided to the EPC 160. The controller/processor 875 is also responsible for error detection using an ACK and/or NACK protocol to support HARQ operations.

At least one of the TX processor 868, the RX processor 856, and the controller/processor 859 may be configured to perform aspects in connection with IQ impairment compensation component 198 of FIG. 1.

At least one of the TX processor 816, the RX processor 870, and the controller/processor 875 may be configured to perform aspects in connection with IQ impairment compensation component 199 of FIG. 1.

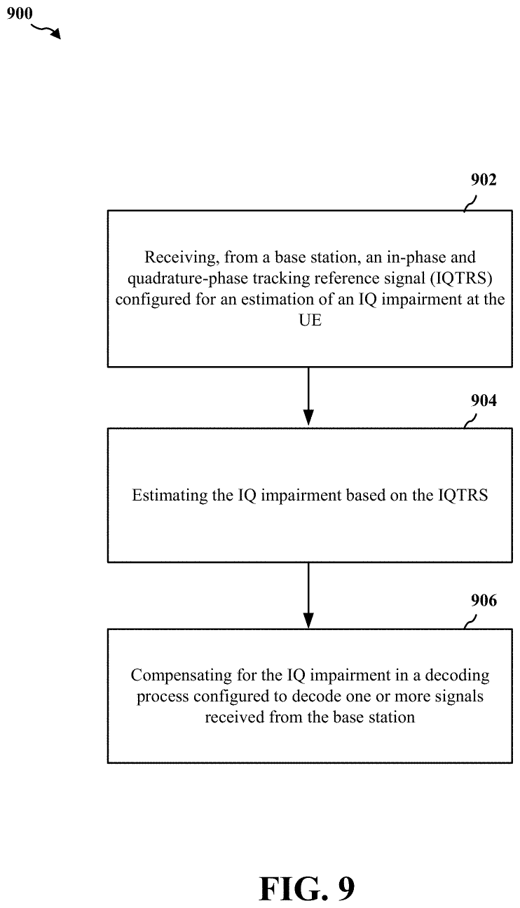

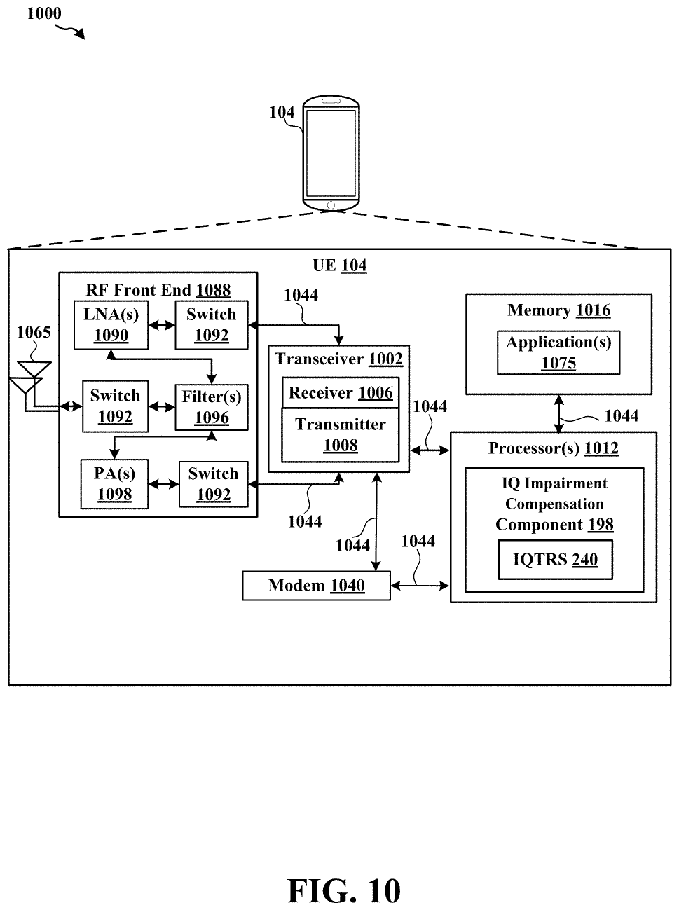

FIG. 9 is a flowchart of a method 900 of wireless communication which may be performed by an apparatus such as a UE 104 or a component of a UE 104 (e.g., the apparatus 850, the controller/processor 859 (which may include the memory 860), the TX processor 868, the RX processor 856, the UE 104 (FIG. 10), processor(s) 1012 (which may include the memory 1016), modem 1040 (which may be the entire UE 104 or a component of the UE 104), and/or the transceiver 1002) in combination with the IQ impairment compensation component 198.

At 902, the method 900 includes receiving, from a base station, an IQTRS configured for an estimation of an IQ impairment at the UE. In an aspect, for example, the UE 104 and/or the IQ impairment compensation component 198 may be configured to receive, from a base station 102, an IQTRS configured for an estimation of an IQ impairment at the UE. As such, the UE 104, the apparatus 850, the controller/processor 859 (which may include the memory 860), the TX processor 868, the RX processor 856, the UE 104, processor(s) 1012 (which may include the memory 1016), modem 1040 (which may be the entire UE 104 or a component of the UE 104), and/or the transceiver 1002), and/or the IQ impairment compensation component 198 may define a means for receiving, from a base station, an IQTRS configured for an estimation of an IQ impairment at the UE.

At 904, the method 900 includes estimating the IQ impairment based on the IQTRS. In an aspect, for example, the UE 104 and/or the IQ impairment compensation component 198 may be configured to estimate the IQ impairment based on the IQTRS. As such, the UE 104, the apparatus 850, the controller/processor 859 (which may include the memory 860), the TX processor 868, the RX processor 856, the UE 104, processor(s) 1012 (which may include the memory 1016), modem 1040 (which may be the entire UE 104 or a component of the UE 104), and/or the transceiver 1002), and/or the IQ impairment compensation component 198 may define a means for estimating the IQ impairment based on the IQTRS.

At 906, the method 900 includes compensating for the IQ impairment in a decoding process configured to decode one or more signals received from the base station. In an aspect, for example, the UE 104 and/or the IQ impairment compensation component 198 may be configured to compensate for the IQ impairment in a decoding process configured to decode one or more signals received from the base station 102. As such, the UE 104, the apparatus 850, the controller/processor 859 (which may include the memory 860), the TX processor 868, the RX processor 856, the UE 104, processor(s) 1012 (which may include the memory 1016), modem 1040 (which may be the entire UE 104 or a component of the UE 104), and/or the transceiver 1002), and/or the IQ impairment compensation component 198 may define a means for compensating for the IQ impairment in a decoding process configured to decode one or more signals received from the base station.

Optionally, in some aspects, for example, the IQ impairment may include at least one of a frequency-selective IQ phase mismatch or a frequency-selective IQ amplitude mismatch.

Optionally, in some aspects, for example, the receiving at 902 may include receiving the IQTRS around a LO frequency known at the UE, where the IQTRS is nonsymmetrical around the LO frequency. In an aspect, for example, the UE 104 and/or the IQ impairment compensation component 198 may be configured to receive the IQTRS around a LO frequency known at the UE, where the IQTRS is nonsymmetrical around the LO frequency. As such, the UE 104, the apparatus 850, the controller/processor 859 (which may include the memory 860), the TX processor 868, the RX processor 856, the UE 104, processor(s) 1012 (which may include the memory 1016), modem 1040 (which may be the entire UE 104 or a component of the UE 104), and/or the transceiver 1002), and/or the IQ impairment compensation component 198 may define a means for receiving the IQTRS around a LO frequency known at the UE, where the IQTRS is nonsymmetrical around the LO frequency.

Optionally, in some aspects, for example, the estimating at 904 may include estimating the IQ impairment based at least in part on a mirrored image of the IQTRS in a frequency domain, where the mirrored image is weaker than the IQTRS and occupies one or more frequencies associated with one or more unoccupied REs. In an aspect, for example, the UE 104 and/or the IQ impairment compensation component 198 may be configured to estimate the IQ impairment based at least in part on a mirrored image of the IQTRS in a frequency domain, where the mirrored image is weaker than the IQTRS and occupies one or more frequencies associated with one or more unoccupied REs. As such, the UE 104, the apparatus 850, the controller/processor 859 (which may include the memory 860), the TX processor 868, the RX processor 856, the UE 104, processor(s) 1012 (which may include the memory 1016), modem 1040 (which may be the entire UE 104 or a component of the UE 104), and/or the transceiver 1002), and/or the IQ impairment compensation component 198 may define a means for estimating the IQ impairment based at least in part on a mirrored image of the IQTRS in a frequency domain, where the mirrored image is weaker than the IQTRS and occupies one or more frequencies associated with one or more unoccupied REs.

Optionally, in some aspects, for example, the IQTRS may include at least one TRS in a cluster of REs in a 2 symbol subframe configured with 1:4 RE separation.

Optionally, in some aspects, for example, the IQTRS may include a DM-RS that is decimated in frequency.

Optionally, in some aspects, for example, the estimating at 904 may include estimating the IQ impairment for each beam used in a beamforming communication between the base station and the UE. In an aspect, for example, the UE 104 and/or the IQ impairment compensation component 198 may be configured to estimate the IQ impairment for each beam used in a beamforming communication between the base station and the UE. As such, the UE 104, the apparatus 850, the controller/processor 859 (which may include the memory 860), the TX processor 868, the RX processor 856, the UE 104, processor(s) 1012 (which may include the memory 1016), modem 1040 (which may be the entire UE 104 or a component of the UE 104), and/or the transceiver 1002), and/or the IQ impairment compensation component 198 may define a means for estimating the IQ impairment for each beam used in a beamforming communication between the base station and the UE.

Optionally, in some aspects, for example, the receiving at 902 may include combining signals received via multiple transmit or receive antennas. In an aspect, for example, the UE 104 and/or the IQ impairment compensation component 198 may be configured to combine signals received via multiple transmit or receive antennas. As such, the UE 104, the apparatus 850, the controller/processor 859 (which may include the memory 860), the TX processor 868, the RX processor 856, the UE 104, processor(s) 1012 (which may include the memory 1016), modem 1040 (which may be the entire UE 104 or a component of the UE 104), and/or the transceiver 1002), and/or the IQ impairment compensation component 198 may define a means for combining signals received via multiple transmit or receive antennas.

Optionally, in some aspects, for example, the compensating at 906 may include transmitting an IQTRS report by the UE to the base station through a feedback channel, where the IQTRS report indicates the IQ impairment affecting the UE. In an aspect, for example, the UE 104 and/or the IQ impairment compensation component 198 may be configured to transmit an IQTRS report by the UE to the base station through a feedback channel, where the IQTRS report indicates the IQ impairment affecting the UE. As such, the UE 104, the apparatus 850, the controller/processor 859 (which may include the memory 860), the TX processor 868, the RX processor 856, the UE 104, processor(s) 1012 (which may include the memory 1016), modem 1040 (which may be the entire UE 104 or a component of the UE 104), and/or the transceiver 1002), and/or the IQ impairment compensation component 198 may define a means for transmitting an IQTRS report by the UE to the base station through a feedback channel, where the IQTRS report indicates the IQ impairment affecting the UE.

Optionally, in some aspects, for example, the compensating at 906 may include a CHEST processing at the UE. In an aspect, for example, the UE 104 and/or the IQ impairment compensation component 198 may be configured to perform a CHEST processing at the UE. As such, the UE 104, the apparatus 850, the controller/processor 859 (which may include the memory 860), the TX processor 868, the RX processor 856, the UE 104, processor(s) 1012 (which may include the memory 1016), modem 1040 (which may be the entire UE 104 or a component of the UE 104), and/or the transceiver 1002), and/or the IQ impairment compensation component 198 may define a means for a CHEST processing at the UE.

Referring to FIG. 10, one example of an implementation of UE 104 may include a variety of components, some of which have already been described above and are described further herein, including components such as one or more processors 1012 and memory 1016 and transceiver 1002 in communication via one or more buses 1044, which may operate in conjunction with modem 1040 and/or IQ impairment compensation component 198 for.

In an aspect, the one or more processors 1012 can include a modem 1040 and/or can be part of the modem 1040 that uses one or more modem processors. Thus, the various functions related to IQ impairment compensation component 198 may be included in modem 1040 and/or processors 1012 and, in an aspect, can be executed by a single processor, while in other aspects, different ones of the functions may be executed by a combination of two or more different processors. For example, in an aspect, the one or more processors 1012 may include any one or any combination of a modem processor, or a baseband processor, or a digital signal processor, or a transmit processor, or a receiver processor, or a transceiver processor associated with transceiver 1002. In other aspects, some of the features of the one or more processors 1012 and/or modem 1040 associated with IQ impairment compensation component 198 may be performed by transceiver 1002.

Also, memory 1016 may be configured to store data used herein and/or local versions of applications 1075 or communicating component 1042 and/or one or more of its subcomponents being executed by at least one processor 1012. Memory 1016 can include any type of computer-readable medium usable by a computer or at least one processor 1012, such as random access memory (RAM), read only memory (ROM), tapes, magnetic discs, optical discs, volatile memory, non-volatile memory, and any combination thereof. In an aspect, for example, memory 1016 may be a non-transitory computer-readable storage medium that stores one or more computer-executable codes defining IQ impairment compensation component 198 and/or one or more of its subcomponents, and/or data associated therewith, when UE 104 is operating at least one processor 1012 to execute IQ impairment compensation component 198 and/or one or more of its subcomponents.

Transceiver 1002 may include at least one receiver 1006 and at least one transmitter 1008. Receiver 1006 may include hardware and/or software executable by a processor for receiving data, the code comprising instructions and being stored in a memory (e.g., computer-readable medium). Receiver 1006 may be, for example, a radio frequency (RF) receiver. In an aspect, receiver 1006 may receive signals transmitted by at least one base station 102. Additionally, receiver 1006 may process such received signals, and also may obtain measurements of the signals, such as, but not limited to, Ec/Io, signal-to-noise ratio (SNR), reference signal received power (RSRP), received signal strength indicator (RSSI), etc. Transmitter 1008 may include hardware and/or software executable by a processor for transmitting data, the code comprising instructions and being stored in a memory (e.g., computer-readable medium). A suitable example of transmitter 1008 may including, but is not limited to, an RF transmitter.

Moreover, in an aspect, UE 104 may include RF front end 1088, which may operate in communication with one or more antennas 1065 and transceiver 1002 for receiving and transmitting radio transmissions, for example, wireless communications transmitted by at least one base station 102 or wireless transmissions transmitted by UE 104. RF front end 1088 may be connected to one or more antennas 1065 and can include one or more low-noise amplifiers (LNAs) 1090, one or more switches 1092, one or more power amplifiers (PAs) 1098, and one or more filters 1096 for transmitting and receiving RF signals.

In an aspect, LNA 1090 can amplify a received signal at a desired output level. In an aspect, each LNA 1090 may have a specified minimum and maximum gain values. In an aspect, RF front end 1088 may use one or more switches 1092 to select a particular LNA 1090 and its specified gain value based on a desired gain value for a particular application.

Further, for example, one or more PA(s) 1098 may be used by RF front end 1088 to amplify a signal for an RF output at a desired output power level. In an aspect, each PA 1098 may have specified minimum and maximum gain values. In an aspect, RF front end 1088 may use one or more switches 1092 to select a particular PA 1098 and its specified gain value based on a desired gain value for a particular application.

Also, for example, one or more filters 1096 can be used by RF front end 1088 to filter a received signal to obtain an input RF signal. Similarly, in an aspect, for example, a respective filter 1096 can be used to filter an output from a respective PA 1098 to produce an output signal for transmission. In an aspect, each filter 1096 can be connected to a specific LNA 1090 and/or PA 1098. In an aspect, RF front end 1088 can use one or more switches 1092 to select a transmit or receive path using a specified filter 1096, LNA 1090, and/or PA 1098, based on a configuration as specified by transceiver 1002 and/or processor 1012.

As such, transceiver 1002 may be configured to transmit and receive wireless signals through one or more antennas 1065 via RF front end 1088. In an aspect, transceiver may be tuned to operate at specified frequencies such that UE 104 can communicate with, for example, one or more base stations 102 or one or more cells associated with one or more base stations 102. In an aspect, for example, modem 1040 can configure transceiver 1002 to operate at a specified frequency and power level based on the UE configuration of the UE 104 and the communication protocol used by modem 1040.

In an aspect, modem 1040 can be a multiband-multimode modem, which can process digital data and communicate with transceiver 1002 such that the digital data is sent and received using transceiver 1002. In an aspect, modem 1040 can be multiband and be configured to support multiple frequency bands for a specific communications protocol. In an aspect, modem 1040 can be multimode and be configured to support multiple operating networks and communications protocols. In an aspect, modem 1040 can control one or more components of UE 104 (e.g., RF front end 1088, transceiver 1002) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, the processor(s) 1012 may correspond to one or more of the processors described in connection with the UE in FIG. 8. Similarly, the memory 1016 may correspond to the memory described in connection with the UE in FIG. 8.

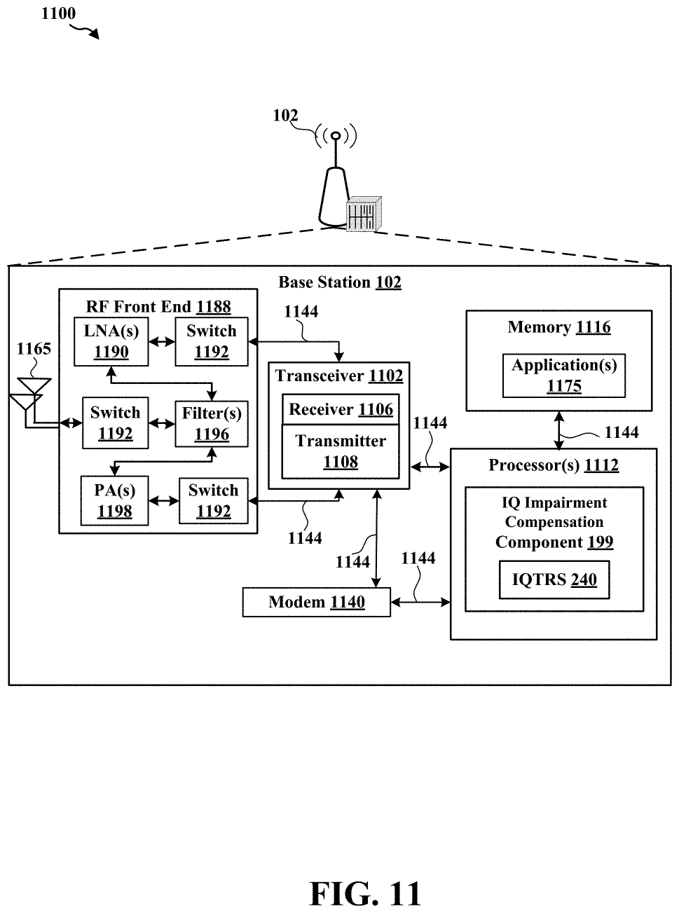

Referring to FIG. 11, one example of an implementation of base station 102 (e.g., a base station 102, as described above) may include a variety of components, some of which have already been described above, but including components such as one or more processors 1112 and memory 1116 and transceiver 1102 in communication via one or more buses 1144, which may operate in conjunction with modem 1140 and IQ impairment compensation component 199 for transmitting IQTRS 240.

The transceiver 1102, receiver 1106, transmitter 1108, one or more processors 1112, memory 1116, applications 1175, buses 1144, RF front end 1188, LNAs 1190, switches 1192, filters 1196, PAs 1198, and one or more antennas 1165 may be the same as or similar to the corresponding components of UE 104, as described above, but configured or otherwise programmed for base station operations as opposed to UE operations.

In an aspect, the processor(s) 1112 may correspond to one or more of the processors described in connection with the base station in FIG. 8. Similarly, the memory 1116 may correspond to the memory described in connection with the base station in FIG. 8.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication at a user equipment (UE), comprising:
receiving, from a base station, an in-phase and quadrature-phase tracking reference signal (IQTRS) configured for an estimation of an IQ impairment at the UE;
estimating the IQ impairment based on the IQTRS; and
compensating for the IQ impairment in a decoding process configured to decode one or more signals received from the base station.

2. The method of claim 1, wherein the IQ impairment comprises at least one of a frequency-selective IQ phase mismatch or a frequency-selective IQ amplitude mismatch.

3. The method of claim 1, wherein the receiving comprises receiving the IQTRS around a local oscillator frequency known at the UE, wherein the IQTRS is nonsymmetrical around the local oscillator frequency.

4. The method of claim 3, wherein the estimating comprises estimating the IQ impairment based at least in part on a mirrored image of the IQTRS in a frequency domain, wherein the mirrored image is weaker than the IQTRS and occupies one or more frequencies associated with one or more unoccupied resource elements (REs).

5. The method of claim 1, wherein the IQTRS comprises at least one TRS in a cluster of resource elements (RE) in a 2 symbol subframe configured with 1:4 RE separation.

6. The method of claim 1, wherein the IQTRS comprises a demodulation reference signal (DM-RS) that is decimated in frequency.

7. The method of claim 1, wherein the estimating comprises estimating the IQ impairment for each beam used in a beamforming communication between the base station and the UE.

8. The method of claim 1, wherein the receiving comprises combining signals received via multiple transmit or receive antennas.

9. The method of claim 1, wherein the compensating comprises transmitting an IQTRS report by the UE to the base station through a feedback channel, wherein the IQTRS report indicates the IQ impairment affecting the UE.

10. The method of claim 1, wherein the compensating comprises a channel estimation (CHEST) processing at the UE.

11. A user equipment (UE) for wireless communication, comprising:
a transceiver;
a memory configured to store instructions; and
one or more processors communicatively coupled with the transceiver and the memory, wherein the one or more processors are configured to execute the instructions to:
receive, from a base station, an in-phase and quadrature-phase tracking reference signal (IQTRS) configured for an estimation of an IQ impairment at the UE;
estimate the IQ impairment based on the IQTRS; and
compensate for the IQ impairment in a decoding process configured to decode one or more signals received from the base station.

12. The UE of claim 11, wherein the IQ impairment comprises at least one of a frequency-selective IQ phase mismatch or a frequency-selective IQ amplitude mismatch.

13. The UE of claim 11, wherein the one or more processors are configured to execute the instructions to receive the IQTRS around a local oscillator frequency known at the UE, wherein the IQTRS is nonsymmetrical around the local oscillator frequency.

14. The UE of claim 13, wherein the one or more processors are configured to execute the instructions to estimate the IQ impairment based at least in part on a mirrored image of the IQTRS in a frequency domain, wherein the mirrored image is weaker than the IQTRS and occupies one or more frequencies associated with one or more unoccupied resource elements (REs).

15. The UE of claim 11, wherein the IQTRS comprises at least one TRS in a cluster of resource elements (RE) in a 2 symbol subframe configured with 1:4 RE separation.

16. The UE of claim 11, wherein the IQTRS comprises a demodulation reference signal (DM-RS) that is decimated in frequency.

17. The UE of claim 11, wherein the one or more processors are configured to execute the instructions to estimate the IQ impairment for each beam used in a beamforming communication between the base station and the UE.

18. The UE of claim 11, wherein the one or more processors are configured to execute the instructions to combine signals received via multiple transmit or receive antennas.

19. The UE of claim 11, wherein the one or more processors are configured to execute the instructions to transmit an IQTRS report by the UE to the base station through a feedback channel, wherein the IQTRS report indicates the IQ impairment affecting the UE.

20. The UE of claim 11, wherein the one or more processors are configured to execute the instructions to compensate for the IQ impairments in a channel estimation (CHEST) processing at the UE.

21. A user equipment (UE) for wireless communication, comprising:
means for receiving, from a base station, an in-phase and quadrature-phase tracking reference signal (IQTRS) configured for an estimation of an IQ impairment at the UE;
means for estimating the IQ impairment based on the IQTRS; and
means for compensating for the IQ impairment in a decoding process configured to decode one or more signals received from the base station.

22. A non-transitory computer-readable medium, comprising code executable by one or more processors to perform wireless communication at a user equipment (UE), comprising:
receiving, from a base station, an in-phase and quadrature-phase tracking reference signal (IQTRS) configured for an estimation of an IQ impairment at the UE;
estimating the IQ impairment based on the IQTRS; and
compensating for the IQ impairment in a decoding process configured to decode one or more signals received from the base station.
